(19) United States
(12) Patent Application Publication
(10) Pub. No.: US 2012/0060934 A1
(43) Pub. Date: Mar. 15, 2012

(54) PIPELINE FLUID HEATING SYSTEM

(76) Inventors: Jeremy Barendregt, Grand Prairie (CA); Calvin A.G. Barendregt, Grand Junction, CO (US); Caleb Barendregt, Wembley (CA)

(21) Appl. No.: 13/229,192

(22) Filed: Sep. 9, 2011

Related U.S. Application Data
(60) Provisional application No. 61/381,176, filed on Sep. 9, 2010.

(51) Int. Cl. F16K 49/00; F16L 53/00

(52) U.S. Cl. 137/13; 285/41; 137/334

(57) ABSTRACT

A system for heating fluid lines to prevent freezing and ice build up. Heated fluid lines are utilized within the pipeline to achieve improved thermal transfer.

### CROSS-REFERENCE TO RELATED APPLICATIONS

This application claims the benefit of U.S. Provisional Application No. 61/381,176, filed on Sep. 9, 2010, the contents of which are hereby incorporated by reference.

### FIELD OF THE INVENTION

This invention relates to preventing ice buildup in fluid transport pipes. More particularly, the invention relates to providing a heating a fluid to warm a fluid inside of large pipes.

### BACKGROUND OF THE INVENTION

In particular climates it is desired to heat, thaw and prevent the freezing of pipelines. The pipelines are used to transfer fluids across a distance, sometimes through areas of cold weather.

Presently, heat exchangers are used to keep the fluid in the pipeline from freezing. However, heat exchangers require that the fluid in the pipeline be flowing in order to be effective. Once the fluid stops moving, the heat exchanger is unable to heat the fluid thereby making the system ineffective.

Another method to heat fluid in a pipeline is to heat the exterior. This requires the installation of heated lines on the exterior surface of the pipe. However, these transfer lines are generally inefficient as much of the heat is lost to the ambient air.

Yet another method, is to insert a device into the line and use a vacuum to draw the fluid from the line. Once drained the fluid is heated and pumped back into the pipeline. This method is both very labor intensive and requires the special equipment such as vacuum trucks.

Therefore, a system for keeping high volumes of fluid from freezing is desired.

Further, a system for keeping fluids from freezing with minimal intervention (disassembly of pipelines, draining and down time) is desired.

Even further, a system to provide safe, continuous heat over long distances, and to easily and quickly thaw frozen pipe is desired.

### SUMMARY OF THE INVENTION

In one form the invention relates to a fluid heating system having a pipeline having a heating insert installed along the length of the pipeline. The heating insert having at least one connector being in communication with a heating line, the heating line being positioned within the diameter of the pipeline. Heated fluid passes through the connector and through the heating line to warm the fluid within the pipeline.

In another embodiment, the invention includes a pipeline having a first opening, a second opening, a first pipeline flange, a second pipeline flange and an inner diameter; a first heating insert having an outer surface, an inner diameter, an opening on each end, two heating insert flange and at least one connector; a second heating insert having an outer surface, an inner diameter, an opening on each end, two heating insert flange and at least one connector; and at least one heating line having a first and second end. The first pipeline flange is attached to a heating insert flange of the first heating insert to form a continuous pipe between the pipeline and the first heating insert. A connector passes through the outer surface of the first heating insert. A second pipeline flange is attached to a heating insert flange of the second heating insert to form a continuous pipe between the pipeline and the second heating insert. A connector passes through the outer surface of the second heating insert. A heating line resides within the continuous pipe formed by the pipeline, the first heating insert and the second heating insert. The first end of the heating line is connected a connector of the first heating insert and the second end of the heating line is connected to a connector of the second heating insert to form a continuous heating line between the connectors.

In yet another embodiment, the invention includes a method for heating the fluid inside of a pipeline. The method has the steps of providing a pipeline having a first opening, a second opening, a first pipeline flange, a second pipeline flange and an inner diameter. Providing a first heating insert having an outer surface, an inner diameter, an opening on each end, two heating insert flange and comprising at least one connector. Providing a second heating insert having an outer surface, an inner diameter, an opening on each end, two heating insert flange and comprising at least one connector. Connecting a first end of a heating line to a connector of the first heating insert and connecting a second end of the heating line to a connector of the second heating insert to form a continuous heating line between the two connectors. Connecting the pipeline flange to a heating insert flange of the first heating insert to form a continuous pipe between the pipeline and the first heating insert. A connector of the first heating insert passing through the outer surface of the first heating insert. Connecting the second pipeline flange to a heating insert flange of the second heating insert to form a continuous pipe between the pipeline and the second heating insert. A connector of the second heating insert passing through the outer surface of the second heating insert. Connecting the connectors of the first and second heating inserts to external lines to form a closed loop and pumping heated fluid through the closed loop to heat the fluid in the pipeline.

### BRIEF DESCRIPTION OF THE DRAWINGS

The present invention is disclosed with reference to the accompanying drawings, wherein:

FIG. 1 is an expanded isometric view of a pipeline having a heating insert and heated fluid lines according to one embodiment.

FIG. 2 is a close up isometric view of the heating insert shown in FIG. 1;

FIG. 3 is an alternative isometric view of the heating insert shown in FIG. 1; and

FIG. 4 is an interior view of the heating insert shown in FIG. 2.

Corresponding reference characters indicate corresponding parts throughout the several views. The examples set out herein illustrates several embodiments of the invention but should not be construed as limiting the scope of the invention in any manner.

### DETAILED DESCRIPTION

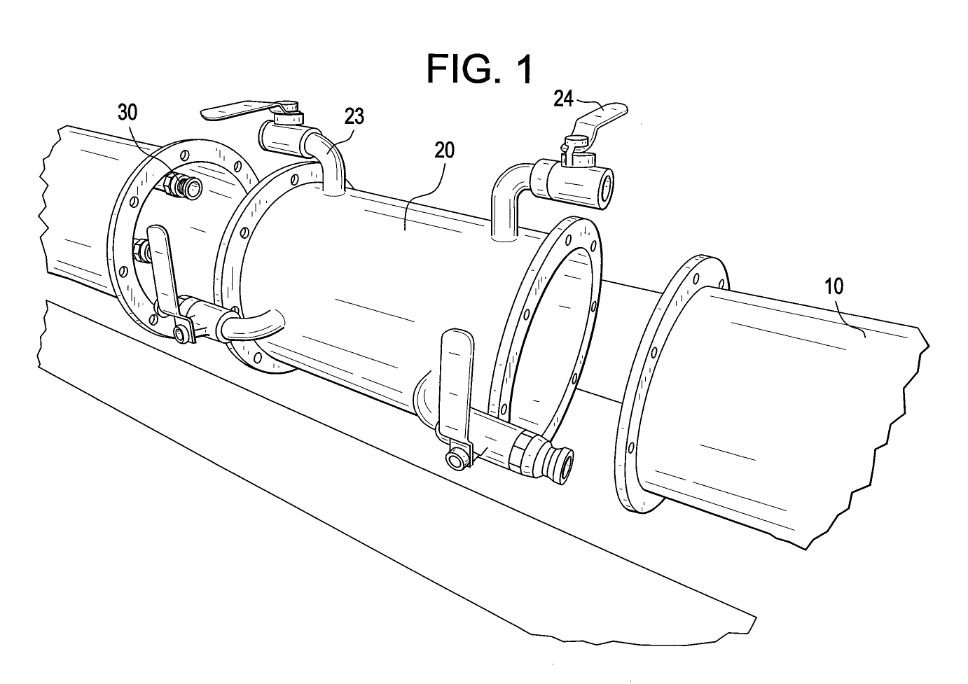

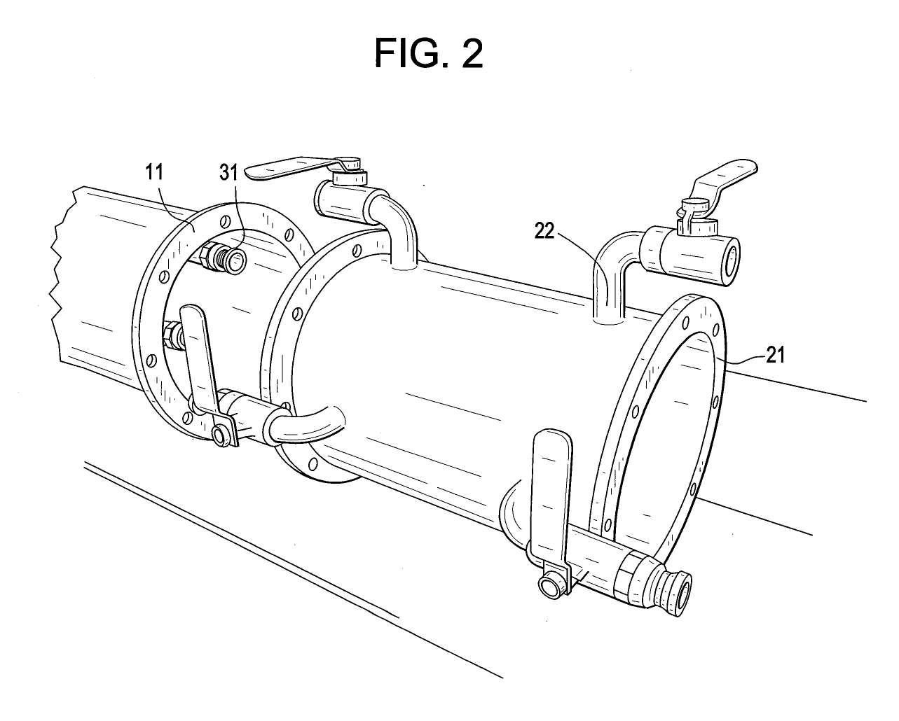

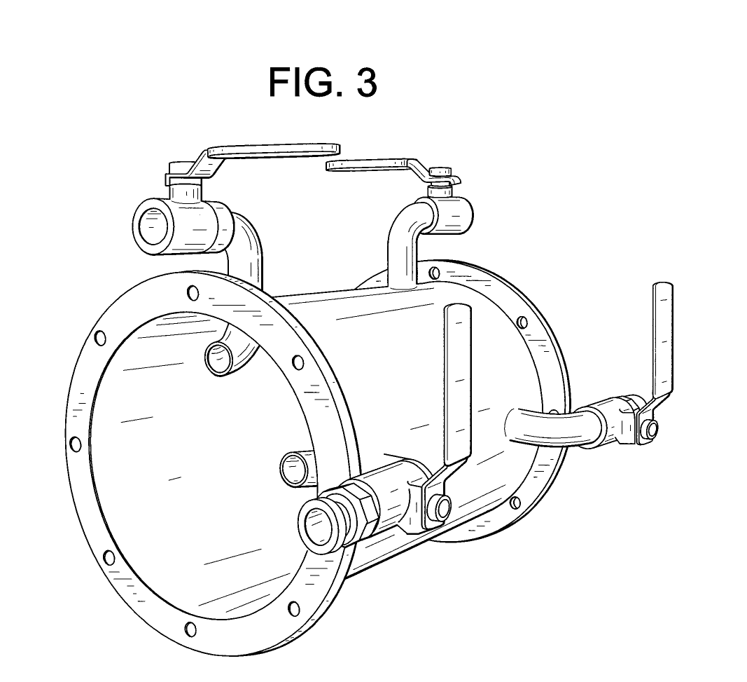

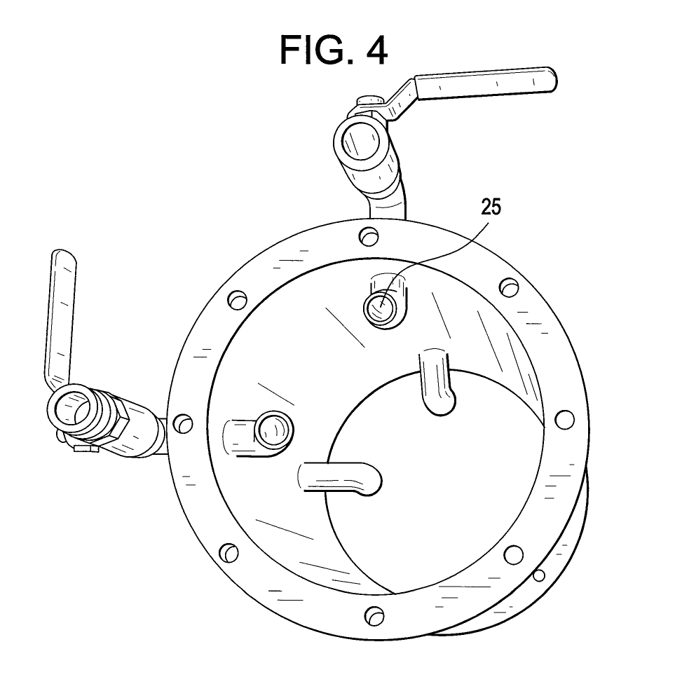

Referring to FIGS. 1-4, there is shown the heating lines for integration with fluid pipes according to one embodiment. To heat the fluid in the pipeline 10, a heating insert 20 is connected between sections of pipeline to allow integration of the heating lines 30. Heated fluid enters through one of the connectors 23 and flows through a heating line 30 before exited a connector on a second heating insert (not shown).

The heating insert 20 is connected in line with the pipeline 10. The pipeline flange 11 is the same diameter as the heating insert flange 21. The two flanges are connected together in a similar manner as connecting sections of pipeline, to form a leak-resistant seal and a continuous pipeline. This connection allows the flow of fluid through the pipeline and heating insert sections.

The heating insert 20 has at least one of connector 23 to allow transfer of heating fluid from the exterior of the pipeline into the interior of the pipeline without leaking heating fluid into the pipeline product itself. The connectors may be either inlet or outlet ports. It is understood that the heating insert may contain any number of connectors. In one embodiment, the heating insert has one inlet and one outlet connectors. In another embodiment, the heating insert has two inlet and two outlet connectors. In yet another embodiment a first heating insert has one inlet port while a second heating insert has one outlet port. The connectors 23 pass through the heating insert 20 at the transition point 22 forming a closed loop that allows the connector to transfer fluid from the outside of the pipe to the heating line inside of the pipe and back out of the pipe through another connector. In one embodiment, the connector 23 further contains a shut off valve 24 to adjust or shut off the flow of heating fluid.

The interior connections 25 connect to the heating line connection 31 of the heating line 30. heating fluid flows through the connector 23 through the heating line 30 to a second connector (not shown) before exiting the system. In one embodiment, an auxiliary pump is used to increase, or provide an adequate flow rate of the heating fluid.

In another embodiment, the connectors are integrated directly into the pipeline 10, without the need for the additional heating insert 20. While the heating insert 20 allows for integration into existing pipelines, a pipeline with integrated connectors and heating lines is ideal for a new builds.

In use, the multiple heating inserts are connected between sections of pipeline. The heating insert attaches to the pipeline in the same manner as connecting multiple pieces of pipeline to form a continuous pipe. Inside the pipeline resides at least one heating line to carry heating fluid through the pipeline. The heating fluid is completely contained within the heating line to prevent the heating fluid from mixing with the fluid in the pipeline. Each end of the heating line connect to connectors found on the heating inserts connected to each end of the pipeline. These connectors allow the heating fluid to be transferred from outside of the pipeline and into the heating line found inside the pipeline when the pipeline is fully assembled and closed. By the heating line residing inside of the pipeline the a more efficient level of heat transfer can be obtained.

While the invention has been described with reference to particular embodiments, it will be understood by those skilled in the art that various changes may be made and equivalents may be substituted for elements thereof without departing from the scope of the invention. In addition, many modifications may be made to adapt a particular situation or material to the teachings of the invention without departing from the scope of the invention.

Therefore, it is intended that the invention not be limited to the particular embodiments disclosed as the best mode contemplated for carrying out this invention, but that the invention will include all embodiments falling within the scope and spirit of the appended claims.

### PARTS LIST

10 pipeline
11 pipeline flange
20 heating insert
21 heating insert flange
22 transition point
23 connectors
24 shut off valve
25 interior connections
30 heating lines
31 heating line connection

1. A fluid heating system comprising:
a pipeline having first opening, a pipeline flange and an inner diameter;
at least one heating line located within the inner diameter of said pipeline; and
a heating insert having an outer surface, an inner diameter, an opening on each end, two heating insert flange and comprising at least one connector, said connector being in communication with said heating line and passing though the outer surface of said heating insert.

2. The fluid heating system of claim 1 wherein said heating insert comprises at least four connectors.

3. The fluid heating system of claim 1 further comprising an auxiliary pump to deliver heated fluid to said at least one connector.

4. The fluid heating system of claim 1 further comprising a second heating insert having an outer surface and comprising at least one connector.

5. The fluid heating system of claim 4 wherein said heating line has a first end and a second end, said first end being in communication with a connector of a first heating insert and said second end being in communication with a connector of a second heating insert.

6. The fluid heating system of claim 5 wherein said heating line, said connector of a first heating insert and said connector of a second heating insert form a closed loop.

7. A fluid heating system comprising:
a pipeline having a first opening, a second opening, a first pipeline flange, a second pipeline flange and an inner diameter;
a first heating insert having an outer surface, an inner diameter, an opening on each end, two heating insert flange and comprising at least one connector;
a second heating insert having an outer surface, an inner diameter, an opening on each end, two heating insert flange and comprising at least one connector; and
at least one heating line having a first and second end;
said first pipeline flange being attached to a heating insert flange of said first heating insert to form a continuous pipe between said pipeline and said first heating insert, said at least one connector passing through the outer surface of said first heating insert;
said second pipeline flange being attached to a heating insert flange of said second heating insert to form a continuous pipe between said pipeline and said second heating insert, said at least second connector passing through the outer surface of said second heating insert;
said at least one heating line residing within the continuous pipe formed by said pipeline, said first heating insert and said second heating insert;
said first end of said heating line being connected to said at least one connector of said first heating insert and said second end of said heating line being connected to said at least one connector of said second heating insert to form a continuous heating line between said at least one connector of said first heating insert and said at least one connector of said second heating insert.

8. The fluid heating system of claim 7 wherein said first heating insert comprises at least four connectors.

9. The fluid heating system of claim 8 wherein said second heating insert comprises at least four connectors.

10. The fluid heating system of claim 7 further comprising an auxiliary pump to deliver heated fluid to said at least one connector.

11. The fluid heating system of claim 7 wherein said pipeline is a fluid pipeline.

12. The fluid heating system of claim 11 wherein said fluid pipeline is a liquid pipeline.

13. The fluid heating system of claim 7 wherein said connecter further comprises a shut off valve.

14. The fluid heating system of claim 7 further comprising a second pipeline having a first opening, a second opening, a first pipeline flange, a second pipeline flange and an inner diameter, said second pipeline flange being attached to the heating insert flange of said first heating insert not attached to said first pipeline flange to form a continuous pipe between said first pipeline, through said heating insert and said second pipeline.

15. A method for heating the fluid inside of a pipeline comprising the steps of:
providing a pipeline having a first opening, a second opening, a first pipeline flange, a second pipeline flange and an inner diameter;
providing a first heating insert having an outer surface, an inner diameter, an opening on each end, two heating insert flange and comprising at least one connector;
providing a second heating insert having an outer surface, an inner diameter, an opening on each end, two heating insert flange and comprising at least one connector;
connecting a first end of a heating line to said at least one connector of said first heating insert and connecting a second end of said heating line to said at least one connector of said second heating insert to form a continuous heating line between said at least one connector of said first heating insert and said at least one connector of said second heating insert
connecting said first pipeline flange to a heating insert flange of said first heating insert to form a continuous pipe between said pipeline and said first heating insert, said at least one connector of said first heating insert passing through the outer surface of said first heating insert;
connecting said second pipeline flange to a heating insert flange of said second heating insert to form a continuous pipe between said pipeline and said second heating insert, said at least one connector of said second heating insert passing through the outer surface of said second heating insert;
connecting said at least one connectors of said first and second heating inserts to external lines to form a closed loop; and
pumping heated fluid through the closed loop.
